(19) United States
(12) Patent Application Publication
(10) Pub. No.: US 2024/0420000 A1
(43) Pub. Date: Dec. 19, 2024

(54) QUANTUM CIRCUIT OPTIMIZATION METHOD, DEVICE, EQUIPMENT AND STORAGE MEDIUM

(71) Applicant: YANGTZE DELTA INDUSTRIAL INNOVATION CENTER OF QUANTUM SCIENCE AND TECHNOLOGY, Suzhou (CN)

(72) Inventors: Tian LUAN, Suzhou (CN); Zaichen ZHANG, Suzhou (CN); Xutao YU, Suzhou (CN); Zetong LI, Suzhou (CN); Fanxu MENG, Suzhou (CN); Shuai HAN, Suzhou (CN); Huide ZHOU, Suzhou (CN)

(21) Appl. No.: 18/820,376

(22) Filed: Aug. 30, 2024

Related U.S. Application Data
(63) Continuation of application No. PCT/CN2023/134303, filed on Nov. 27, 2023.

(30) Foreign Application Priority Data
Dec. 19, 2022 (CN) 202211632717.9

(51) Int. Cl. G06N 10/20

(52) U.S. Cl. CPC G06N 10/20

(57) ABSTRACT

The present application discloses a quantum circuit optimization method, a device, equipment and a storage medium, which are applied to the technical field of quantum computing and include the steps of: obtaining a quantum circuit to be optimized; determining an optimization unit in the quantum circuit to be optimized, and replacing the optimization unit with a comprehensive expression to obtain a first optimized quantum circuit; the optimization unit corresponding to at least two-bit Pauli operators; replacing the comprehensive expression with an equivalent circuit according to a preset standard and circuits before and after the comprehensive expression to form a second optimized quantum circuit; the second optimized quantum circuit including an eliminable quantum gate; and performing gate elimination on the second optimized quantum circuit to obtain an optimized quantum circuit.

### CROSS-REFERENCE TO RELATED APPLICATIONS

The present application is a continuation of International Application No. PCT/CN2023/134303, with an international filing date of Nov. 27, 2023, which is based upon and claims priority to Chinese Patent Application No. 202211632717.9, filed on Dec. 19, 2022, the entire contents of all of which are incorporated herein by reference.

### TECHNICAL FIELD

The present disclosure relates to a technical field of quantum computing, and particularly to a quantum circuit optimization method, a quantum circuit optimization device, quantum circuit optimization equipment, and a computer-readable storage medium.

### BACKGROUND

There are still many limitations of the present quantum computers, and the fully fault-tolerant quantum computers are not yet available. We must use so-called noise-containing medium-scale quantum equipment, characterized in that quantum computers, with quantum bits ranging from 50 to a few hundred, lack full-scale quantum error correction and the strict limitations they impose on the operational circuits. The main limitations are a finite number of quantum bits and a finite operational quantum circuit depth (quantum circuits cannot parallelize the number of the operational quantum gate layers). In order to reduce the requirements on quantum computers and improve the operation efficiency, quantum circuit optimization algorithm is usually adopted to reduce the number of quantum gates and decrease the depth of quantum circuits. Therefore, many complex quantum algorithms can rely on quantum circuit optimization algorithms to run on the noise-containing medium-scale quantum equipment.

Pauli operators X, Y, Z can form nine forms of two-bit Pauli operators, which are denoted as P⊗P, wherein P∈{X, Y, Z}. The two-bit Pauli operator P⊗P corresponds to the quantum circuit of e^{-iθP}^{ⱼ}^{⊗P}^{ₖ}, wherein j and k represent quantum bit on which the Pauli operators act, respectively. Quantum circuit optimization algorithm has many different simplification rules and applicable scenarios, and the nine two-bit Pauli operators such as X⊗X, X⊗Y, X⊗Z, Y⊗X, Y⊗Y, Y⊗Z, Z⊗X, Z⊗Y and Z⊗Z can cover all two-bit Pauli operators. Such circuits are common in quantum computing, such as quantum Hamiltonian simulations, unitary matrix decomposition, etc. Accordingly, it is an urgent problem to be solved by those skilled in the art to provide a technical solution for quantum circuit optimization.

### SUMMARY

The object of the present disclosure is to provide a quantum circuit optimization method, which can simplify the structure of the quantum circuit. A further object of the present disclosure is to provide a quantum circuit optimization device, quantum circuit optimization equipment, and a computer-readable storage medium, which can simplify the structure of the quantum circuit.

To solve the above technical problem, the present disclosure provides a quantum circuit optimization method, comprising the steps of:
obtaining a quantum circuit to be optimized;
determining an optimization unit in the quantum circuit to be optimized, and replacing the optimization unit with a comprehensive expression to obtain a first optimized quantum circuit; the optimization unit corresponding to at least two-bit Pauli operators;
replacing the comprehensive expression with an equivalent circuit according to a preset standard and circuits before and after the comprehensive expression to form a second optimized quantum circuit; the second optimized quantum circuit comprising an eliminable quantum gate; and
performing gate elimination on the second optimized quantum circuit to obtain an optimized quantum circuit.

Optionally, the step of determining an optimization unit in the quantum circuit to be optimized, and replacing the optimization unit with a comprehensive expression to obtain a first optimized quantum circuit comprises:
taking a two-bit Pauli operator as an optimization unit, determining an optimization unit in the quantum circuit to be optimized, and replacing the optimization unit with a comprehensive expression to obtain a first optimized quantum circuit.

Optionally, the comprehensive expression comprises:
X⊗X, X⊗Y, X⊗Z, Y⊗X, Y⊗Y, Y⊗Z, Z⊗X, Z⊗Y, Z⊗Z.

Optionally, the step of replacing the comprehensive expression with an equivalent circuit according to a preset standard and circuits before and after the comprehensive expression to form a second optimized quantum circuit comprises:
determining priority of each to-be-selected equivalent circuit corresponding to the comprehensive expression according to the circuits before and after the comprehensive expression; the priority comprising a high priority and a low priority, the high priority being a priority corresponding to a to-be-selected equivalent circuit for enabling the second optimized quantum circuit to have an eliminable quantum gate; the low priority being a priority corresponding to a to-be-selected equivalent circuit with the shallowest circuit depth; the high priority overriding the low priority in the same to-be-selected equivalent circuit; and
selecting a to-be-selected equivalent circuit to replace the corresponding comprehensive expression according to priority order from high to low to form a second optimized quantum circuit.

Optionally, the priority includes a first priority, a second priority, a third priority, and a fourth priority; the first priority being a priority corresponding to a to-be-selected equivalent circuit for enabling the second optimized quantum circuit to have an eliminable CNOT gate;
the second priority being a priority corresponding to a to-be-selected equivalent circuit for enabling the second optimized quantum circuit to have an eliminable single-bit gate;
the third priority being a priority corresponding to a to-be-selected equivalent circuit with the shallowest circuit depth;
the fourth priority being a priority corresponding to a to-be-selected equivalent circuit which does not belong to the first priority, the second priority and the third priority;
the step of selecting a to-be-selected equivalent circuit to replace the corresponding comprehensive expression according to priority order from high to low to form a second optimized quantum circuit comprises:
taking the highest priority as an actual priority according to the priority order when the to-be-selected equivalent circuit corresponds to a plurality of priorities; the priority order being an order of a first priority, a second priority, a third priority and a fourth priority; and
selecting a to-be-selected equivalent circuit to replace the corresponding comprehensive expression according to the actual priority order from front to back to form a second optimized quantum circuit.

Optionally, the step of selecting a to-be-selected equivalent circuit to replace the corresponding comprehensive expression according to the actual priority order from front to back to form a second optimized quantum circuit comprises:
randomly selecting a to-be-elected equivalent circuit from the selected to-be-selected equivalent circuits to replace the corresponding comprehensive expression to form a second optimized quantum circuit when the number of the selected to-be-selected equivalent circuits is not less than two.

Optionally, the step of determining priority of each to-be-selected equivalent circuit corresponding to the comprehensive expression according to the circuits before and after the comprehensive expression comprises:
combining the to-be-selected equivalent circuits corresponding to the continuous comprehensive expressions, and comprehensively determining the priority of the to-be-selected equivalent circuits after combination according to the circuits before and after the comprehensive expressions when a plurality of comprehensive expressions appear continuously.

The present disclosure further provides a quantum circuit optimization device, comprising:
an acquisition module for obtaining a quantum circuit to be optimized;
a first optimized quantum circuit module for determining an optimization unit in the quantum circuit to be optimized, and replacing the optimization unit with a comprehensive expression to obtain a first optimized quantum circuit; the optimization unit corresponding to at least two-bit Pauli operators;
a second optimized quantum circuit module for replacing the comprehensive expression with an equivalent circuit according to a preset standard and circuits before and after the comprehensive expression to form a second optimized quantum circuit; the second optimized quantum circuit comprising an eliminable quantum gate; and
a gate elimination module for performing gate elimination on the second optimized quantum circuit to obtain an optimized quantum circuit.

The present disclosure further provides quantum circuit optimization equipment, comprising:
a memory for storing computer program; and
a processor for implementing the steps of a quantum circuit optimization method as described previously when executing the computer program.

The present disclosure further provides a computer-readable storage medium which has a computer program stored thereon, the computer program being executed by a processor to implement the steps of a quantum circuit optimization method as described previously.

A quantum circuit optimization method provided by the present disclosure comprises the steps of: obtaining a quantum circuit to be optimized; determining an optimization unit in the quantum circuit to be optimized, and replacing the optimization unit with a comprehensive expression to obtain a first optimized quantum circuit; the optimization unit corresponding to at least two-bit Pauli operators; replacing the comprehensive expression with an equivalent circuit according to a preset standard and circuits before and after the comprehensive expression to form a second optimized quantum circuit; the second optimized quantum circuit comprising an eliminable quantum gate; and performing gate elimination on the second optimized quantum circuit to obtain an optimized quantum circuit.

The structure of the quantum circuit can be effectively simplified, and the optimization of the quantum circuit is realized by determining a corresponding comprehensive expression by extracting an optimization unit of a quantum circuit to be optimized, replacing the comprehensive expression into an equivalent circuit based on the comprehensive expression, and enabling the quantum circuit to comprise an eliminable quantum gate during replacement; and finally, performing gate elimination.

The present disclosure further provides a quantum circuit optimization device, quantum circuit optimization equipment, and a computer-readable storage medium, which can achieve the above advantageous effects, and thus it will not be described in detail herein.

### BRIEF DESCRIPTION OF THE DRAWINGS

In order to more clearly explain the technical solutions in the embodiments of the present disclosure or the prior art, drawings required in the embodiments or the prior art will be briefly described below. Obviously, the drawings in the following description are some embodiments of the present disclosure. For those skilled in the art, other drawings may be obtained from these drawings without any creative effort.

FIG. 1 is a flow diagram of a quantum circuit optimization method according to the embodiments of the present disclosure;

FIG. 2 is an equivalent circuit diagram of X⊗X;

FIG. 3 is an equivalent circuit diagram of X⊗Y;

FIG. 4 is an equivalent circuit diagram of X⊗Z;

FIG. 5 is an equivalent circuit diagram of Y⊗X;

FIG. 6 is an equivalent circuit diagram of Y⊗Y;

FIG. 7 is an equivalent circuit diagram of Y⊗Z;

FIG. 8 is an equivalent circuit diagram of Z⊗X;

FIG. 9 is an equivalent circuit diagram of Z⊗Y;

FIG. 10 is an equivalent circuit diagram of Z⊗Z;

FIG. 11 is a flow diagram of a specific quantum circuit optimization method according to the embodiments of the present disclosure;

FIG. 12 is a known quantum circuit to be optimized according to the embodiments of the present disclosure;

FIG. 13 is a first optimized quantum circuit corresponding to FIG. 12;

FIG. 14 is a second optimized quantum circuit corresponding to FIG. 13;

FIG. 15 is an optimized quantum circuit corresponding to FIG. 14;

FIG. 16 is a structure diagram of a quantum circuit optimization device according to the embodiments of the present disclosure;

FIG. 17 is a structure diagram of quantum circuit optimization equipment according to the embodiments of the present disclosure.

### DETAILED DESCRIPTION OF THE EMBODIMENTS

The core of the present disclosure is to provide a quantum circuit optimization method. In the prior art, Pauli operators X, Y, Z can form nine forms of two-bit Pauli operators, which are denoted as P⊗P, wherein PE {X, Y, Z}. The two-bit Pauli operator P⊗P corresponds to the quantum circuit of e^{-iθP}^{ⱼ}^{⊗P}^{ₖ}, wherein j and k represent quantum bit on which the Pauli operators act, respectively. Quantum circuit optimization algorithm has many different simplification rules and applicable scenarios, and the nine two-bit Pauli operators such as X⊗X, X⊗Y, X⊗Z, Y⊗X, Y⊗Y, Y⊗Z, Z⊗X, Z⊗Y and Z⊗Z can cover all two-bit Pauli operators. Such circuits are common in quantum computing, such as quantum Hamiltonian simulations, unitary matrix decomposition, etc.

A quantum circuit optimization method provided by the present disclosure comprises the steps of: obtaining a quantum circuit to be optimized; determining an optimization unit in the quantum circuit to be optimized, and replacing the optimization unit with a comprehensive expression to obtain a first optimized quantum circuit; the optimization unit corresponding to at least two-bit Pauli operators; replacing the comprehensive expression with an equivalent circuit according to a preset standard and circuits before and after the comprehensive expression to form a second optimized quantum circuit; the second optimized quantum circuit comprising an eliminable quantum gate; and performing gate elimination on the second optimized quantum circuit to obtain an optimized quantum circuit.

The structure of the quantum circuit can be effectively simplified, and the optimization of the quantum circuit is realized by determining a corresponding comprehensive expression by extracting an optimization unit of a quantum circuit to be optimized, replacing the comprehensive expression into an equivalent circuit based on the comprehensive expression, and enabling the quantum circuit to comprise an eliminable quantum gate during replacement; and finally, performing gate elimination.

In order to enable those skilled in the art to better understand the aspects of the present disclosure, the present disclosure will now be described in further detail with reference to the accompanying drawings and detailed description. Obviously, the described embodiments are part of, but not all of, the embodiments of the present disclosure. Based on the embodiments of the present disclosure, all the other embodiments obtained by those skilled in the art without paying any creative work fall within the protection scope of the present disclosure.

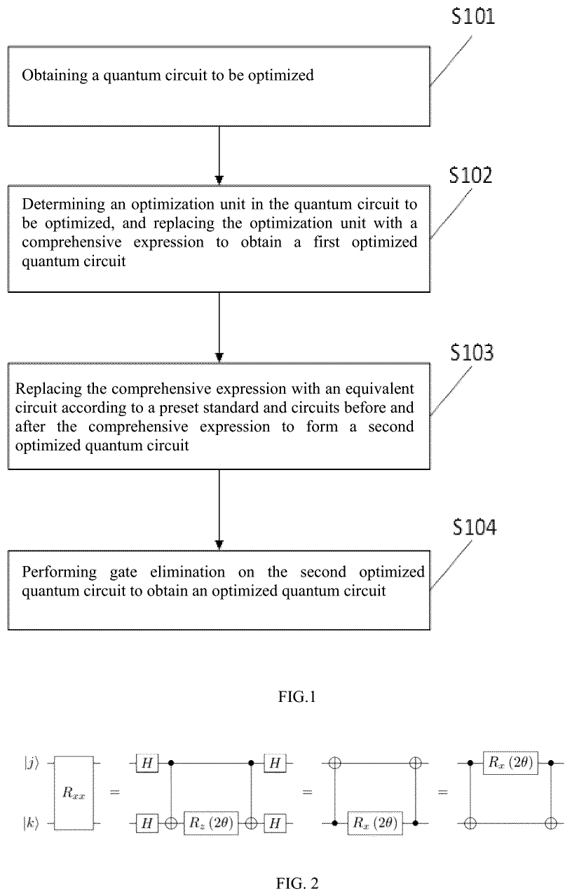

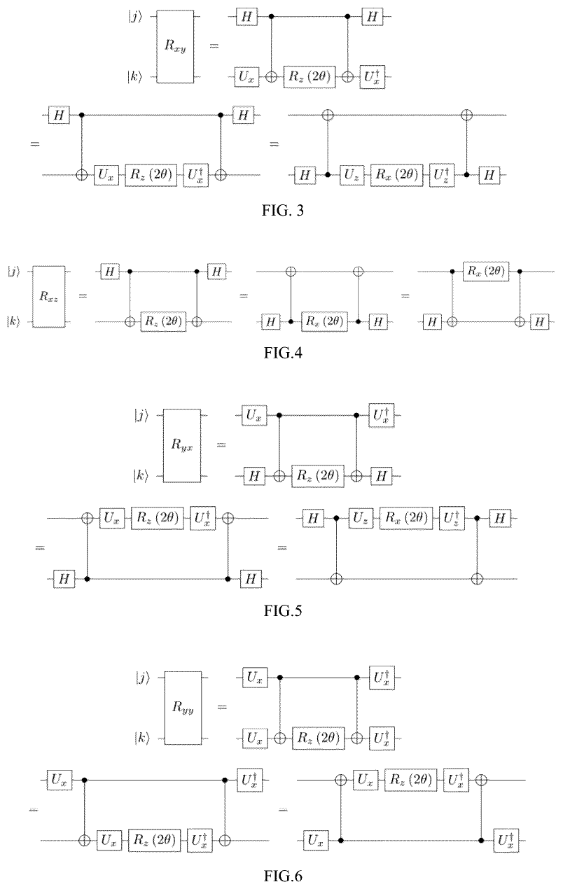

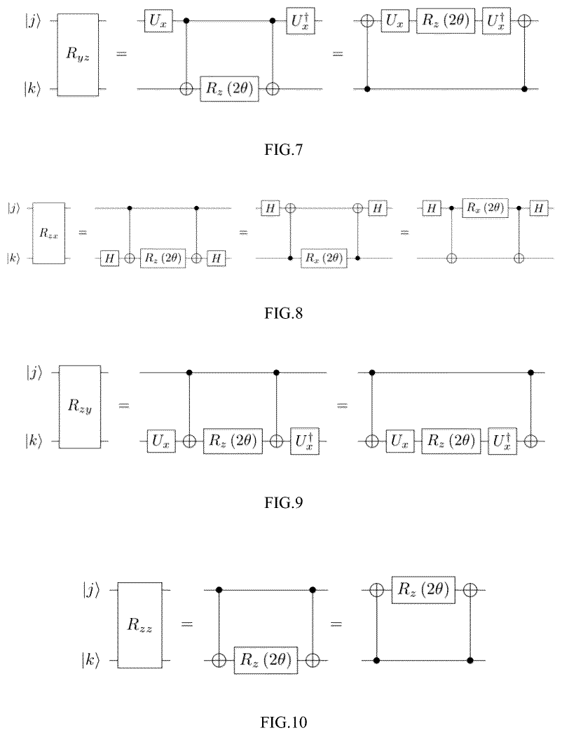

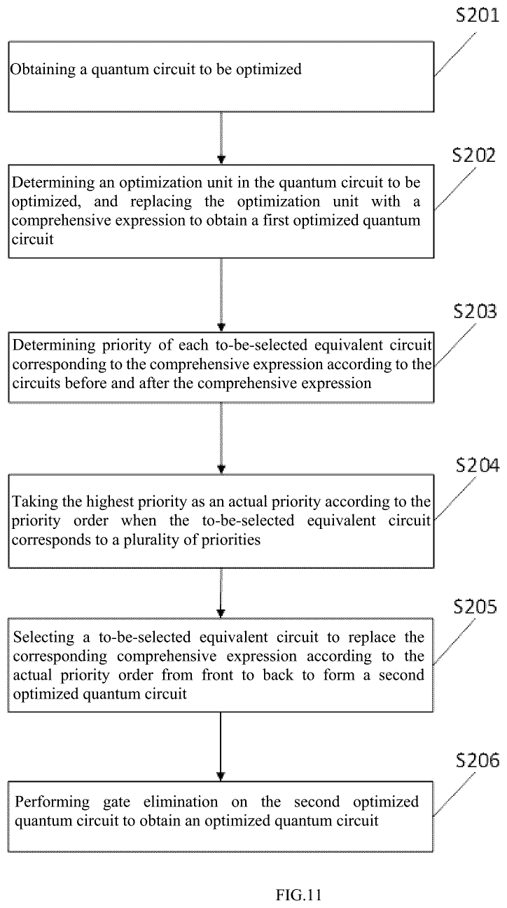

With reference to FIGS. 1 to 10, FIG. 1 is a flow diagram of a quantum circuit optimization method according to the embodiments of the present disclosure; FIG. 2 is an equivalent circuit diagram of X⊗X; FIG. 3 is an equivalent circuit diagram of X⊗Y; FIG. 4 is an equivalent circuit diagram of X⊗Z; FIG. 5 is an equivalent circuit diagram of Y⊗X; FIG. 6 is an equivalent circuit diagram of Y⊗Y; FIG. 7 is an equivalent circuit diagram of Y⊗Z; FIG. 8 is an equivalent circuit diagram of Z⊗X; FIG. 9 is an equivalent circuit diagram of Z⊗Y; and FIG. 10 is an equivalent circuit diagram of Z⊗Z.

Referring to FIG. 1, in the embodiments of the present disclosure, a quantum circuit optimization method comprises the steps of:

S101: obtaining a quantum circuit to be optimized.

The quantum circuit to be optimized is a quantum circuit before optimization, and the specific process of acquiring the quantum circuit to be optimized can be set automatically according to actual conditions, and is not specifically limited herein.

S102: determining an optimization unit in the quantum circuit to be optimized, and replacing the optimization unit with a comprehensive expression to obtain a first optimized quantum circuit.

In the embodiments of the present disclosure, the optimization unit corresponds to at least two-bit Pauli operators. In the embodiments of the present disclosure, the Pauli operators of a plurality of continuous bits are regarded as an optimization unit, the optimization unit is searched for and determined in the quantum circuit to be optimized, and then the optimization unit is replaced by a corresponding comprehensive expression to obtain a first optimized quantum circuit. The above optimization unit corresponds to at least two-bit Pauli operators, and certainly it may also correspond to more-bit Pauli operators, such as three-bit Pauli operators. Of course, at this stage, since quantum computers are usually calculated in binary, the optimization unit described above usually consists of only a two-bit Pauli operator. Correspondingly, the step specifically comprises taking a two-bit Pauli operator as an optimization unit, determining an optimization unit in the quantum circuit to be optimized, and replacing the optimization unit with a comprehensive expression to obtain a first optimized quantum circuit.

Specifically, the comprehensive expression in the embodiments of the present disclosure comprises:

X⊗X, X⊗Y, X⊗Z, Y⊗X, Y⊗Y, Y⊗Z, Z⊗X, Z⊗Y, Z⊗Z.

In other words, in the embodiments of the present disclosure, the above nine Pauli operators are used as the comprehensive expressions. In the embodiments of the present disclosure, each comprehensive expression corresponds to a plurality of equivalent circuits, and the specific contents thereof can be referred to FIGS. 2 to 10. The first of each of FIGS. 2 to 10 represents a type of the two-bit Pauli operator, wherein Rⱼₖ=J⊗K, j, k∈{x, y, z}, J, K∈{X, Y, Z}. All circuits except the first are equivalent circuits for the two-bit Pauli operator. The circuits are marked as the first equivalent circuit, the second equivalent circuit, in order from left to right, from top to bottom, until all the equivalent circuits are marked, wherein Uₓ=Rₓ(π/2), Uₓ^{t}=Bₓ(−π/2), U_{z}=R_{z}(π/2), U_{z}^{t}=B_{z}(−π/2), H represents a single-bit Hadamard gate, R_{z} represents R_{z}(2θ), and Rₓ represents Rₓ(2θ).

In this step, an optimization unit may be determined from the circuit to be optimized according to the corresponding relationship between the comprehensive expression and the equivalent circuit in FIGS. 2 to 10, and the optimization unit may be replaced by the corresponding comprehensive expression to obtain a first optimized quantum circuit.

It should be noted that in the embodiments of the present disclosure, the above process of determining the optimization unit may specifically use a depth-first search algorithm or a breadth-first search algorithm to mark the searched optimization unit, e.g., the position of the two-bit Pauli operator. It should be noted that when replacing with a comprehensive expression, it is necessary to keep the input and output of the replacement position unchanged.

S103: replacing the comprehensive expression with an equivalent circuit according to a preset standard and circuits before and after the comprehensive expression to form a second optimized quantum circuit.

In the embodiments of the present disclosure, the second optimized quantum circuit comprises an eliminable quantum gate. In other words, in this step, the equivalent circuit selected by the preset standard can enable the second optimized quantum circuit to include an eliminable quantum gate, so that the gate elimination is performed in the subsequent step, thereby simplifying the structure of the quantum circuit. Specifically, since two continuous H gates (Hadamard gates) can be eliminated, two continuous CNOT gates (with the same bits acting on the control end and the output end, respectively) can be eliminated, and the same type of single quantum rotating gates with opposite phases can be eliminated, etc., it is necessary to make the second optimized quantum circuit include the above eliminable quantum gate to form the second optimized quantum circuit when the equivalent circuit is determined according to the above preset standard.

Specifically, the step may comprise: determining priority of each to-be-selected equivalent circuit corresponding to the comprehensive expression according to the circuits before and after the comprehensive expression; the priority comprising a high priority and a low priority, the high priority being a priority corresponding to a to-be-selected equivalent circuit for enabling the second optimized quantum circuit to have an eliminable quantum gate; the low priority being a priority corresponding to a to-be-selected equivalent circuit with the shallowest circuit depth; the high priority overriding the low priority in the same to-be-selected equivalent circuit; and selecting a to-be-selected equivalent circuit to replace the corresponding comprehensive expression according to priority order from high to low to form a second optimized quantum circuit.

Since a comprehensive expression corresponds to a plurality of to-be-selected equivalent circuits, the priority of each to-be-selected equivalent circuit in the first optimized quantum circuit will be determined first in this step. It should be noted that differences in the first optimized quantum circuit may lead to different priorities for the same to-be-selected equivalent circuits.

The above priorities include at least two types of priorities, a high priority and a low priority. The high priority may cause the second optimized line to have an eliminable quantum gate after replacing the corresponding comprehensive expression with the to-be-selected equivalent circuit. In other words, the high priority is a priority corresponding to a to-be-selected equivalent circuit for enabling the second optimized quantum circuit to have an eliminable quantum gate. The low priority is a priority corresponding to a to-be-selected equivalent circuit with the shallowest circuit depth. In other words, after the corresponding comprehensive expression is replaced by the quantum circuit corresponding to the low priority, the circuit depth of the replaced quantum circuit is not increased at least. When the same to-be-selected equivalent circuit corresponds to a plurality of priorities, the higher priority will override the lower priority, i.e., the to-be-selected equivalent circuit that can eliminate quantum gates will be limitedly selected to replace the comprehensive expression in this step to simplify the circuit structure.

After the priority of each to-be-selected equivalent circuit is determined, the to-be-selected equivalent circuit can be selected to replace the corresponding comprehensive expression according to the priority order from high to low to form a second optimized quantum circuit, so that the whole second optimized quantum circuit has an eliminable quantum gate.

The specific contents of the priority will be described in detail in the following embodiments of the present disclosure and will not be described in detail herein.

S104: performing gate elimination on the second optimized quantum circuit to obtain an optimized quantum circuit.

In this step, gate elimination may be specifically performed on the second optimized quantum circuit through a gate elimination strategy, for example, eliminating two continuous H gates, eliminating two continuous CNOT gates, eliminating the same type of single quantum rotating gates with opposite phases, etc., to obtain an optimized quantum circuit.

The quantum circuit optimization method provided by the present disclosure can effectively simplify the structure of the quantum circuit and realize the optimization of the quantum circuit by determining a corresponding comprehensive expression by extracting an optimization unit of a quantum circuit to be optimized, replacing the comprehensive expression into an equivalent circuit based on the comprehensive expression, and enabling the quantum circuit to comprise an eliminable quantum gate during replacement; and finally, performing gate elimination.

The specific contents of the quantum circuit optimization method will be described in detail in the following embodiments of the present disclosure.

With reference to FIG. 11, FIG. 11 is a flow diagram of a specific quantum circuit optimization method according to the embodiments of the present disclosure.

Referring to FIG. 11, in the embodiments of the present disclosure, a quantum circuit optimization method comprises the steps of:

S201: obtaining a quantum circuit to be optimized.

S202: determining an optimization unit in the quantum circuit to be optimized, and replacing the optimization unit with a comprehensive expression to obtain a first optimized quantum circuit.

The above S201 to S202 are basically the same as S101 to S102 in the above embodiment of the present disclosure. Please refer to the above embodiment of the present disclosure for details, and the detailed description will not be repeated herein.

S203: determining priority of each to-be-selected equivalent circuit corresponding to the comprehensive expression according to the circuits before and after the comprehensive expression.

In this step, the priority of each to-be-selected equivalent circuit corresponding to the comprehensive expression is determined by combining the circuits before and after the comprehensive expression, for example, whether there is an H gate before and after the comprehensive expression. In the embodiments of the present disclosure, the priority includes a first priority, a second priority, a third priority, and a fourth priority according to priority order from high to low and from front to back; the first priority being a priority corresponding to a to-be-selected equivalent circuit for enabling the second optimized quantum circuit to have an eliminable CNOT gate; the second priority being a priority corresponding to a to-be-selected equivalent circuit for enabling the second optimized quantum circuit to have an eliminable single-bit gate; the third priority being a priority corresponding to a to-be-selected equivalent circuit with the shallowest circuit depth; and the fourth priority being a priority corresponding to a to-be-selected equivalent circuit which does not belong to the first priority, the second priority and the third priority.

In other words, for a certain comprehensive expression, in the corresponding to-be-selected equivalent circuit, if the comprehensive expression is replaced by the to-be-selected equivalent circuit, the second optimized quantum circuit can be made to have repetitive CNOT gates, i.e., having eliminable CNOT gates, and the to-be-selected equivalent circuit will be given a first priority. If the comprehensive expression is replaced by the to-be-selected equivalent circuit, the second optimized quantum circuit can be made to have repetitive H gates, i.e., having eliminable H gates, and the to-be-selected equivalent circuit will be given a second priority. Since the complexity of the CNOT gate is greater than the complexity of the H gate, it will be possible to eliminate the CNOT gate as the first priority and the H gate as the second priority.

For a certain comprehensive expression, in the corresponding to-be-selected equivalent circuits, the to-be-selected equivalent circuit with the shallowest circuit depth is given the third priority, and if the circuit depth is the same, the third priority will be given at the same time. If a to-be-selected equivalent circuit does not have any of the above priorities, a fourth priority is given. At this time, a to-be-selected equivalent circuit in the embodiments of the present disclosure may be given a plurality of priorities.

S204: taking the highest priority as an actual priority according to the priority order when the to-be-selected equivalent circuit corresponds to a plurality of priorities.

In the embodiments of the present disclosure, the priority order is an order of a first priority, a second priority, a third priority and a fourth priority. In this step, when the to-be-selected equivalent circuit corresponds to a plurality of priorities, the highest priority is selected as the corresponding actual priority. The priority order is an order of a first priority, a second priority, a third priority and a fourth priority. For example, when the to-be-selected equivalent circuit has a first priority, the actual priority thereof is the first priority. In other words, the higher priority overrides the lower priority.

S205: selecting a to-be-selected equivalent circuit to replace the corresponding comprehensive expression according to the actual priority order from front to back to form a second optimized quantum circuit.

When the priority of each to-be-selected equivalent circuit is determined, the to-be-selected equivalent circuit corresponding to the highest priority is selected from the to-be-selected equivalent circuits to replace its corresponding comprehensive expression, thereby forming the second optimized quantum circuit.

Specifically, the step may comprise: randomly selecting a to-be-elected equivalent circuit from the selected to-be-selected equivalent circuits to replace the corresponding comprehensive expression to form a second optimized quantum circuit when the number of the selected to-be-selected equivalent circuits is not less than two.

In other words, when the number of to-be-elected equivalent circuits that can be selected is more than one, for example, there are two to-be-elected equivalent circuits with the first priority at the same time, one to-be-elected equivalent circuit is selected randomly in this step to replace the corresponding comprehensive expression to form the second optimized quantum circuit.

Specifically, the above S203 may comprise: determining priority of each to-be-selected equivalent circuit corresponding to the comprehensive expression according to the circuits before and after the comprehensive expression in turn in an order from front to back along the first optimized circuit. Correspondingly, the above S205 may specifically comprise: after determining priority of each to-be-selected equivalent circuit corresponding to the comprehensive expression, selecting a to-be-selected equivalent circuit to replace the corresponding comprehensive expression according to priority order from high to low until all of the comprehensive expressions are replaced, so as to form a second optimized quantum circuit.

In other words, it is possible in the embodiments of the present disclosure to sequentially determine the priority of each comprehensive expression corresponding to the to-be-selected equivalent circuit. After determining the priority of each to-be-selected equivalent circuit corresponding to the comprehensive expression, the comprehensive expression can be replaced by selecting the to-be-selected equivalent circuit according to the priority, and then the priority of the next comprehensive expression corresponding to the to-be-selected equivalent circuit is calculated in an order from front to back along the first optimized circuit. The comprehensive expression is replaced by selecting the to-be-selected equivalent circuit according to the priority, all of the comprehensive expressions are replaced, so as to obtain a second optimized quantum circuit.

Of course, in the embodiments of the present disclosure, it is also possible to simultaneously determine the priority of each to-be-selected equivalent circuits corresponding to all of the comprehensive expressions and then replace them uniformly. It should be noted that when the comprehensive expressions appear continuously, their priorities are taken into account, for example, if the two-bit Pauli operators X⊗X and Z⊗Z appear continuously, the equivalent circuits of the two-bit Pauli operators X⊗X and Z⊗Z shall be considered comprehensively and simultaneously, and then the priority of the equivalent circuits is evaluated according to the priority rule. That is, when a plurality of comprehensive expressions appear continuously and there is no separate quantum gate there between for segmentation, the priorities of the to-be-selected equivalent circuits corresponding to the plurality of comprehensive expressions need to be considered comprehensively. Usually, the to-be-selected equivalent circuits corresponding to the continuous comprehensive expression are combined, and the priority of the to-be-selected equivalent circuits after the combination is determined comprehensively. It is advantageous that when the two comprehensive expressions X⊗X and Z⊗Z appear continuously, X⊗X corresponds to three to-be-selected equivalent circuits, and Z⊗Z corresponds to two to-be-selected equivalent circuits. At this time, six types of to-be-selected equivalent circuits will be obtained. And in this step, the six types of to-be-selected equivalent circuits will be considered comprehensively and the priority thereof will be determined. Therefore, in the embodiments of the present disclosure, when a plurality of comprehensive expressions appear continuously, the to-be-selected equivalent circuits corresponding to the continuous comprehensive expressions are combined, and the priority of the to-be-selected equivalent circuits after combination according to the circuits before and after the comprehensive expressions is determined comprehensively.

S206: performing gate elimination on the second optimized quantum circuit to obtain an optimized quantum circuit.

The step is basically the same as S104 in the above embodiment of the present disclosure. Please refer to the above embodiment of the present disclosure for details, and the detailed description will not be repeated herein.

The quantum circuit optimization method provided by the embodiment of the present disclosure can simplify the structure of the quantum circuit as much as possible and realize the optimization of the quantum circuit by setting different levels of priorities.

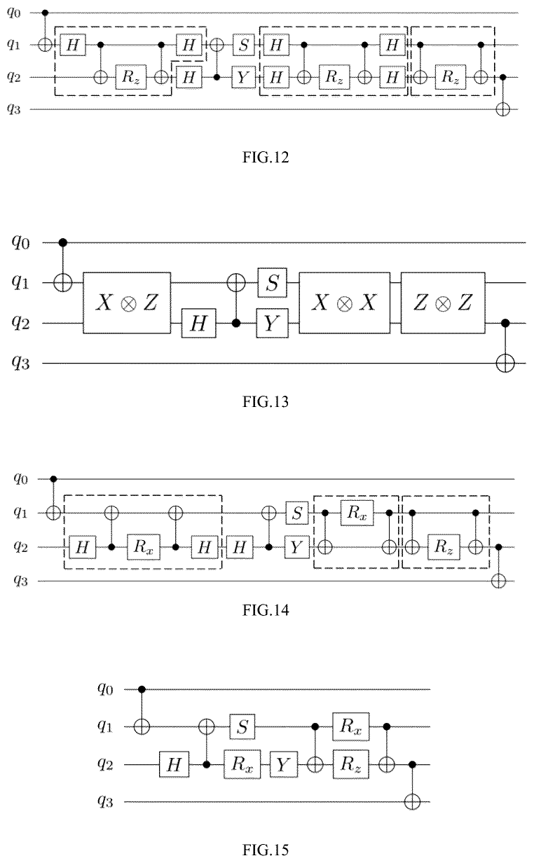

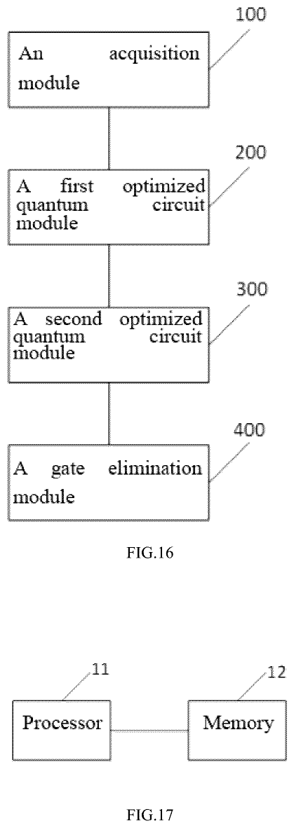

With reference to FIGS. 12 to 15, FIG. 12 is a known quantum circuit to be optimized according to the embodiments of the present disclosure; FIG. 13 is a first optimized quantum circuit corresponding to FIG. 12; FIG. 14 is a second optimized quantum circuit corresponding to FIG. 13; and FIG. 15 is an optimized quantum circuit corresponding to FIG. 14.

Referring to FIGS. 12 to 13, in the embodiments of the present disclosure, a two-bit Pauli operator in a quantum circuit to be optimized is firstly searched and replaced by a comprehensive expression to obtain a first optimized quantum circuit. After searching for the optimization unit, i.e., the two-bit Pauli operator, the position is marked. In the dashed box of FIG. 13, the searched two-bit Pauli operator is marked. It can be seen from the figure that there are three two-bit Pauli operators. In addition, S represents a single-bit phase gate and Y represents a single-bit Pauli Y gate in the figure. Combined with the above accompanying figures, it can be seen that the comprehensive expressions corresponding to the two-bit Pauli operators in the three dashed boxes from left to right in the above circuit are X⊗Z, X⊗X, and Z⊗Z, respectively, and the replaced quantum circuit is shown in FIG. 13.

Afterwards, it is necessary to determine the priority of each to-be-selected equivalent circuit, and in the embodiment, the first two-bit Pauli operator X⊗Z determines the priority of each equivalent circuit according to a rule. First, the first to-be-selected equivalent circuit of the two-bit Pauli operator X⊗Z is replaced by the comprehensive expression and brought in, considering in conjunction with the front and back circuits, it does not satisfy the first priority condition and the second priority condition of the rule, i.e., the CNOT gate and the single-bit gate cannot be eliminated after replacement, and thus the equivalent circuit does not have the first priority and the second priority. Considering the third priority condition, the first equivalent circuit of the two-bit Pauli operator X⊗Z has the same depth with the remaining two equivalent circuits, so that the first equivalent circuit of the two-bit Pauli operator X⊗Z has the third priority. Then, considering the second equivalent circuit of the two-bit Pauli operator X⊗Z, the equivalent circuit is replaced by the comprehensive expression and brought in, considering in conjunction with the front and back circuits, it satisfies the first priority condition and the second priority condition of the rule. After replacement, the two single-bit H gates (Hadamard gates) may be eliminated first, followed by the elimination of two CNOT gates, and thus the equivalent circuit has the first priority and the second priority. Considering the third priority condition, the second equivalent circuit of the two-bit Pauli operator X⊗Z has the same depth with the remaining two equivalent circuits, and also satisfies the third priority condition. The second equivalent circuit of the two-bit Pauli operator X⊗Z has the first, second and third priorities at the same time, and the highest priority needs to be retained according to the rule, and thus the second equivalent circuit of the two-bit Pauli operator X⊗Z is the first priority. Then, considering the third equivalent circuit of the two-bit Pauli operator X⊗Z, the equivalent circuit is replaced by the comprehensive expression and brought in, considering in conjunction with the front and back circuits, it satisfies the second priority condition, i.e., two single-bit H gates (Hadamard gates) can be eliminated after replacement, and thus the equivalent circuit has the second priority. Considering the third priority condition, the third equivalent circuit of the two-bit Pauli operator X⊗Z has the same depth with the remaining two equivalent circuits, and also satisfies the third priority condition. The third equivalent circuit of the two-bit Pauli operator X⊗Z has the first, second and third priorities at the same time, and the highest priority needs to be retained according to the rule, and thus the second equivalent circuit of the two-bit Pauli operator X⊗Z is the second priority. According to the rule, the equivalent circuit with higher priority is selected when the equivalent circuit is replaced. Therefore, the second equivalent circuit of the two-bit Pauli operator X⊗Z is replaced by the comprehensive expression.

The second and third two-bit Pauli operators X⊗X and Z⊗Z are consecutive and are considered simultaneously according to the rule. According to the priority rule, the first equivalent circuit of X⊗X, a two-bit Pauli operator, does not satisfy the first priority condition and the second priority condition when the two-bit Pauli operator Z⊗Z takes different equivalent circuits, i.e., the CNOT gate and the single-bit gate cannot be eliminated after replacement, and the equivalent circuit is not the three equivalent circuits with the shallowest circuit depth, nor does it satisfy the third priority condition. Therefore, according to the fourth priority condition, the first equivalent circuit of the two-bit Pauli operator X⊗X is the fourth priority. The second equivalent circuit of the two-bit Pauli operator X⊗X does not satisfy the first priority condition and the second priority condition when the two-bit Pauli operator Z⊗Z takes the first equivalent circuit, i.e., the CNOT gate and the single-bit gate cannot be eliminated after replacement. However, the equivalent circuit is the one with the shallowest circuit depth in the three equivalent circuits and satisfies the third priority condition, and thus the second equivalent circuit of the two-bit Pauli operator X⊗X is the third priority when the two-bit Pauli operator Z⊗Z takes the first equivalent circuit.

Similarly, the second equivalent circuit of the two-bit Pauli operator X⊗X is the first priority when the two-bit Pauli operator Z⊗Z takes the second equivalent circuit. The third equivalent circuit of the two-bit Pauli operator X⊗X is the first priority when the two-bit Pauli operator Z⊗Z takes the first equivalent circuit. The third equivalent circuit of the two-bit Pauli operator X⊗X is the third priority when the two-bit Pauli operator Z⊗Z takes the second equivalent circuit. When considering the two-bit Pauli operator X⊗X, the two-bit Pauli operator Z⊗Z is taken into account. For the two-bit Pauli operator Z⊗Z, the priority of its equivalent circuit is also related to the fact that X⊗X, a two-bit Pauli operator, takes a different equivalent circuit. According to the analysis of the above method, the first equivalent circuit of the two-bit Pauli operator Z⊗Z is the third priority when the two-bit Pauli operator X⊗X takes the first equivalent circuit. The first equivalent circuit of the two-bit Pauli operator Z⊗Z is the third priority when the two-bit Pauli operator X⊗X takes the second equivalent circuit. The first equivalent circuit of the two-bit Pauli operator Z⊗Z is the first priority when the two-bit Pauli operator X⊗X takes the third equivalent circuit. The second equivalent circuit of the two-bit Pauli operator Z⊗Z is the third priority when the two-bit Pauli operator X⊗X takes the first equivalent circuit. The second equivalent circuit of the two-bit Pauli operator Z⊗Z is the first priority when the two-bit Pauli operator X⊗X takes the second equivalent circuit. The second equivalent circuit of the two-bit Pauli operator Z⊗Z is the third priority when the two-bit Pauli operator X⊗X takes the third equivalent circuit. Considering several different possibilities for selecting equivalent circuits for X⊗X and Z⊗Z, it is assessed that X⊗X, Z⊗Z are the first priorities when taking the second equivalent circuit and the second equivalent circuit or the third equivalent circuit and the first equivalent circuit, respectively, and that the two solutions have the same priority and are both the highest, and one of the two solutions can be selected randomly. As a result of the random selection in the embodiment, the two-bit Pauli operators X⊗X and Z⊗Z take the third equivalent circuit and the first equivalent circuit, respectively. Through the above operation, a second optimized quantum circuit as shown in FIG. 14 can be obtained.

Finally, gate elimination is performed on the second optimized quantum circuit to obtain an optimized quantum circuit. The gate elimination rule includes deleting two continuous H gates (Hadamard gates) and two continuous CNOT gates (with the same bits acting on the control end and the output end, respectively) of the same circuit to obtain an optimized quantum circuit equivalent to the original quantum circuit. FIG. 15 shows the optimized quantum circuit obtained by performing gate elimination on the equivalent second optimized quantum circuit. Comparing FIG. 15 with FIG. 12, it can be seen that the number of quantum gates and the circuit depth in the optimized quantum circuit are reduced compared with the original quantum circuit to be optimized.

The quantum circuit optimization device provided by the embodiment of the present disclosure is described below. The quantum circuit optimization device described below and the quantum circuit optimization method described above may be correspondingly referred to each other.

With reference to FIG. 16, FIG. 16 is a structure diagram of a quantum circuit optimization device according to the embodiments of the present disclosure. Referring to FIG. 16, a quantum circuit optimization device may comprise:
an acquisition module 100 for obtaining a quantum circuit to be optimized;
a first optimized quantum circuit module 200 for determining an optimization unit in the quantum circuit to be optimized, and replacing the optimization unit with a comprehensive expression to obtain a first optimized quantum circuit; the optimization unit corresponding to at least two-bit Pauli operators;
a second optimized quantum circuit module 300 for replacing the comprehensive expression with an equivalent circuit according to a preset standard and circuits before and after the comprehensive expression to form a second optimized quantum circuit; the second optimized quantum circuit comprising an eliminable quantum gate; and
a gate elimination module 400 for performing gate elimination on the second optimized quantum circuit to obtain an optimized quantum circuit.

Preferably, in the embodiments of the present disclosure, a first optimized quantum circuit module 200 is specifically used for:
taking a two-bit Pauli operator as an optimization unit, determining an optimization unit in the quantum circuit to be optimized, and replacing the optimization unit with a comprehensive expression to obtain a first optimized quantum circuit.

Preferably, in the embodiments of the present disclosure, the comprehensive expression comprises:
X⊗X, X⊗Y, X⊗Z, Y⊗X, Y⊗Y, Y⊗Z, Z⊗X, Z⊗Y, Z⊗Z.

Preferably, in the embodiments of the present disclosure, a second optimized quantum circuit module 300 comprises:
a priority unit for determining priority of each to-be-selected equivalent circuit corresponding to the comprehensive expression according to the circuits before and after the comprehensive expression; the priority comprising a high priority and a low priority, the high priority being a priority corresponding to a to-be-selected equivalent circuit for enabling the second optimized quantum circuit to have an eliminable quantum gate; the low priority being a priority corresponding to a to-be-selected equivalent circuit with the shallowest circuit depth; the high priority overriding the low priority in the same to-be-selected equivalent circuit; and
a second optimized quantum circuit unit for selecting a to-be-selected equivalent circuit to replace the corresponding comprehensive expression according to priority order from high to low to form a second optimized quantum circuit.

Preferably, in the embodiments of the present disclosure, the priority includes a first priority, a second priority, a third priority, and a fourth priority; the first priority being a priority corresponding to a to-be-selected equivalent circuit for enabling the second optimized quantum circuit to have an eliminable CNOT gate;
the second priority being a priority corresponding to a to-be-selected equivalent circuit for enabling the second optimized quantum circuit to have an eliminable single-bit gate;
the third priority being a priority corresponding to a to-be-selected equivalent circuit with the shallowest circuit depth;
the fourth priority being a priority corresponding to a to-be-selected equivalent circuit which does not belong to the first priority, the second priority and the third priority.

The second optimized quantum circuit unit comprises:
an actual priority subunit for taking the highest priority as an actual priority according to the priority order when the to-be-selected equivalent circuit corresponds to a plurality of priorities; the priority order being an order of a first priority, a second priority, a third priority and a fourth priority; and
a second optimized quantum circuit subunit for selecting a to-be-selected equivalent circuit to replace the corresponding comprehensive expression according to the actual priority order from front to back to form a second optimized quantum circuit.

Preferably, in the embodiments of the present disclosure, the second optimized quantum circuit subunit is specifically used for:
randomly selecting a to-be-elected equivalent circuit from the selected to-be-selected equivalent circuits to replace the corresponding comprehensive expression to form a second optimized quantum circuit when the number of the selected to-be-selected equivalent circuits is not less than two.

Preferably, in the embodiments of the present disclosure, the priority unit is specifically used for:
combining the to-be-selected equivalent circuits corresponding to the continuous comprehensive expressions, and comprehensively determining the priority of the to-be-selected equivalent circuits after combination according to the circuits before and after the comprehensive expressions when a plurality of comprehensive expressions appear continuously.

The quantum circuit optimization device in the embodiment is used to implement the above quantum circuit optimization method. Therefore, the specific implementation of the design module for quantum circuit optimization can be referred to the embodiment part of the quantum circuit optimization method. For example, an acquisition module 100, a first optimized quantum circuit module 200, a second optimized quantum circuit module 300, and a gate elimination module 400 are used respectively for implementing steps S101 to S104 of the above quantum circuit optimization method. Therefore, the embodiments thereof can be referred to the corresponding descriptions of the respective partial embodiments in the above context, and will not be described in detail herein.

The quantum circuit optimization equipment provided by the embodiment of the present disclosure is described below. The quantum circuit optimization equipment described below and the quantum circuit optimization method and the quantum circuit optimization device described above may be correspondingly referred to each other.

With reference to FIG. 17, FIG. 17 is a structure diagram of quantum circuit optimization equipment according to the embodiments of the present disclosure.

Referring to FIG. 17, the quantum circuit optimization equipment may comprise a processor 11 and a memory 12.

The memory 12 is used for storing computer program. The processor 11 is used for implementing the specific contents of the quantum circuit optimization method as claimed in the above embodiments of the present disclosure when executing the computer program.

The processor 11 in the quantum circuit optimization equipment of the present embodiment is used to install the quantum circuit optimization device described in the above embodiments of the present disclosure, and at the same time, the processor 11 in combination with the memory 12 can realize the quantum circuit optimization method described in any of the above embodiments of the present disclosure. Therefore, the specific implementation of the quantum circuit optimization equipment can be referred to the embodiment part of the quantum circuit optimization method. The embodiments thereof can be referred to the corresponding descriptions of the respective partial embodiments in the above context, and will not be described in detail herein.

The present disclosure further provides a computer-readable storage medium. The computer-readable storage medium has a computer program stored thereon, the computer program being executed by a processor to implement a quantum circuit optimization method as described in any of the above embodiments of the present disclosure. The rest of the contents can be referred to the prior art and will not be described herein without further development.

Each embodiment in the specification is described in a progressive manner, each embodiment focuses on the differences from other embodiments, and the same or similar parts among the embodiments can be referred to each other. For the device disclosed in the embodiments, the description thereof is relatively simple since it corresponds to the method disclosed in the embodiments. For the relevant information, please refer to the description of the method.

Those skilled in the art may further realize that the units and algorithmic steps of the examples described in conjunction with the embodiments disclosed herein can be implemented in electronic hardware, computer software, or a combination thereof. To clearly illustrate the interchangeability of hardware and software, the components and steps of the examples have been described generally in terms of function in the above description. Whether these functions are performed in hardware or software depends on the particular application and design constraints of the technical solution. Those skilled in the art may use different methods to implement the described functions for each particular application, but such implementations should not be considered as going beyond the scope of the present disclosure.

The steps of the methods or algorithms described in conjunction with the embodiments disclosed herein may be implemented directly with hardware, a software module executed by a processor, or a combination thereof. A software module may be placed in random access memory (RAM), memory, read-only memory (ROM), electrically programmable ROM, electrically eliminable programmable ROM, a register, a hard disk, a removable diskette, a CD-ROM, or any other form of storage medium known in the art.

Finally, it should also be noted that relationship terms such as first and second, etc. are used herein only to distinguish one entity or operation from another without necessarily requiring or implying any such actual relationship or order between those entities or operations. Moreover, the terms “comprise”, “include” or any other variation thereof, are intended to cover a non-exclusive inclusion, such that a process, a method, an article, or an apparatus comprising a list of elements includes not only those elements, but also other elements not explicitly listed or may include elements inherent to the process, method, article, or apparatus. Without further limitation, an element defined by the statement of “comprising a . . . ” does not exclude the further presence of additionally identical elements in a process, a method, an article or an apparatus comprising said element.

A quantum circuit optimization method, a device, equipment and a storage medium are described in detail in the present disclosure. Specific examples are used herein to illustrate the principles and embodiments of the present disclosure, and the above description of the examples is merely intended to aid in the understanding of the methods of the present disclosure and the core concepts thereof. It should be noted that those skilled in the art can make several improvements and modifications to the present disclosure without departing from the principles of the present disclosure, and these improvements and modifications also fall within the protection scope of the claims of the present disclosure.

What is claimed is:

1. A quantum circuit optimization method, comprising the steps of:
obtaining a quantum circuit to be optimized;
determining an optimization unit in the quantum circuit to be optimized, and replacing the optimization unit with a comprehensive expression to obtain a first optimized quantum circuit; the optimization unit corresponding to at least two-bit Pauli operators;
replacing the comprehensive expression with an equivalent circuit according to a preset standard and circuits before and after the comprehensive expression to form a second optimized quantum circuit; the second optimized quantum circuit comprising an eliminable quantum gate; and
performing gate elimination on the second optimized quantum circuit to obtain an optimized quantum circuit.

2. The method according to claim 1, wherein the step of determining an optimization unit in the quantum circuit to be optimized, and replacing the optimization unit with a comprehensive expression to obtain a first optimized quantum circuit comprises:
taking a two-bit Pauli operator as an optimization unit, determining an optimization unit in the quantum circuit to be optimized, and replacing the optimization unit with a comprehensive expression to obtain a first optimized quantum circuit.

3. The method according to claim 2, wherein the comprehensive expression comprises:
X⊗X, X⊗Y, X⊗Z, Y⊗X, Y⊗Y, Y⊗Z, Z⊗X, Z⊗Y, Z⊗Z.

4. The method according to claim 2, wherein the step of replacing the comprehensive expression with an equivalent circuit according to a preset standard and circuits before and after the comprehensive expression to form a second optimized quantum circuit comprises:
determining priority of each to-be-selected equivalent circuit corresponding to the comprehensive expression according to the circuits before and after the comprehensive expression; the priority comprising a high priority and a low priority, the high priority being a priority corresponding to a to-be-selected equivalent circuit for enabling the second optimized quantum circuit to have an eliminable quantum gate; the low priority being a priority corresponding to a to-be-selected equivalent circuit with the shallowest circuit depth; the high priority overriding the low priority in the same to-be-selected equivalent circuit; and
selecting a to-be-selected equivalent circuit to replace the corresponding comprehensive expression according to priority order from high to low to form a second optimized quantum circuit.

5. The method according to claim 4, wherein the priority comprises a first priority, a second priority, a third priority, and a fourth priority; the first priority being a priority corresponding to a to-be-selected equivalent circuit for enabling the second optimized quantum circuit to have an eliminable CNOT gate;
the second priority being a priority corresponding to a to-be-selected equivalent circuit for enabling the second optimized quantum circuit to have an eliminable single-bit gate;
the third priority being a priority corresponding to a to-be-selected equivalent circuit with the shallowest circuit depth;
the fourth priority being a priority corresponding to a to-be-selected equivalent circuit which does not belong to the first priority, the second priority and the third priority;
the step of selecting a to-be-selected equivalent circuit to replace the corresponding comprehensive expression according to priority order from high to low to form a second optimized quantum circuit comprises:
taking the highest priority as an actual priority according to the priority order when the to-be-selected equivalent circuit corresponds to a plurality of priorities; the priority order being an order of a first priority, a second priority, a third priority and a fourth priority; and
selecting a to-be-selected equivalent circuit to replace the corresponding comprehensive expression according to the actual priority order from front to back to form a second optimized quantum circuit.

6. The method according to claim 5, wherein the step of selecting a to-be-selected equivalent circuit to replace the corresponding comprehensive expression according to the actual priority order from front to back to form a second optimized quantum circuit comprises:
randomly selecting a to-be-elected equivalent circuit from the selected to-be-selected equivalent circuits to replace the corresponding comprehensive expression to form a second optimized quantum circuit when the number of the selected to-be-selected equivalent circuits is not less than two.

7. The method according to claim 5, wherein the step of determining priority of each to-be-selected equivalent circuit corresponding to the comprehensive expression according to the circuits before and after the comprehensive expression comprises:
combining the to-be-selected equivalent circuits corresponding to the continuous comprehensive expressions, and comprehensively determining the priority of the to-be-selected equivalent circuits after combination according to the circuits before and after the comprehensive expressions when a plurality of comprehensive expressions appear continuously.

8. A quantum circuit optimization device, comprising:
an acquisition module for obtaining a quantum circuit to be optimized;
a first optimized quantum circuit module for determining an optimization unit in the quantum circuit to be optimized, and replacing the optimization unit with a comprehensive expression to obtain a first optimized quantum circuit; the optimization unit corresponding to at least two-bit Pauli operators;
a second optimized quantum circuit module for replacing the comprehensive expression with an equivalent circuit according to a preset standard and circuits before and after the comprehensive expression to form a second optimized quantum circuit; the second optimized quantum circuit comprising an eliminable quantum gate; and
a gate elimination module for performing gate elimination on the second optimized quantum circuit to obtain an optimized quantum circuit.

9. Quantum circuit optimization equipment, comprising:
a memory for storing computer program; and
a processor for implementing the steps of a quantum circuit optimization method according to claim 1 when executing the computer program.

10. A computer-readable storage medium, wherein the computer-readable storage medium has a computer program stored thereon, the computer program being executed by a processor to implement the steps of a quantum circuit optimization method according to claim 1.
